(19) United States
(12) Patent Application Publication
(10) Pub. No.: US 2005/0219690 A1
(43) Pub. Date: Oct. 6, 2005

(54) Riflescope and the laser rangefinder used therein

(75) Inventors: Chen Yeh Lin, Taichung (TW); Liang Shang Yung, Taichung (TW)

Correspondence Address: TROXELL LAW OFFICE PLLC, SUITE 1404, 5205 LEESBURG PIKE, FALLS CHURCH, VA, 22041, US

(73) Assignee: Asia Optical Co., Inc.

(21) Appl. No.: 11/061,657

(22) Filed: Feb. 22, 2005

(30) Foreign Application Priority Data
Apr. 6, 2004 (TW) 093109483

(51) Int. Cl. G02B 23/00

(52) U.S. Cl. 359/429; 359/399

(57) ABSTRACT

An optical system for a riflescope (10) includes an objective element (11), an eyepiece element (17), an LD (12), an APD prism (130), an erector lens (15), an LED prism (160) and an LED panel (16). The erector lens is positioned between a first focal plane (18) and a second focal plane (19). The reticle is disposed at a distance of the second focal length so as to coincide with on the second focal plane. The LED prism is positioned between the erector lens and the second focal plane. The image of data of the range displayed by the LED panel is projected on the second focal plane through the LED prism. By this arrangement, the size and brightness of the reticle and the image of data of the range will not grow or shrink along with the target image size when the magnification is changed, and thus the shooter's vision feeling can be improved.

### BACKGROUND OF THE INVENTION

1. Field of the Invention

The present invention relates to a riflescope, and particularly relates to a riflescope having the reticle coinciding with a second focal plane (eyepiece plane) thereof and the image of data of the range also projected to the second focal plane.

2. Description of Prior Art

It is well known that a riflescope employs optics to provide a magnified view of the target aimed at and helps the shooter to distinguish a distant target from its background. Therefore, the riflescope is applicable to carry out precise shooting in the distant aim. As shown in FIG. 1, the optical system for a conventional riflescope 90 basically includes an objective element 91, an erector lens 92, an eyepiece (ocular lens) element 93 and a reticle 94 for facilitating aiming at the target. As the reticle 94 is disposed coinciding with a second focal plane (eyepiece plane) of the riflescope 90, the image of the reticle 94 will not be affected by the erecting system, i.e., the erector lens 92. This kind of riflescope may be used as a simple rangefinder by roughly estimating the distance of the target with the reticle 94.

FIG. 2 illustrates the optical system of a currently available riflescope 80 with increased accuracy. The optical system of the riflescope 80 primarily includes an objective element 81, a Laser Diode (LD) 82, an LD prism 820, an Avalanche Photoelectric Diode (APD) 83, an APD prism 830, a Light Emitting Diode (LED) panel 86, an LED lens element 860, an LED prism 861, an erector lens 85 and an eyepiece element 87. The LD 82 acts as a light emitter, and the APD 83 acts as a light receiver. The light emitter and the light receiver constitute a laser rangefinder for the riflescope 80. The laser rangefinder is based on the principle of measuring the travel time of a laser pulse or laser pulse sequence emitted by the light emitter. The laser pulse or pulse sequence is reflected by the target aimed at. Part of this reflected light hits the light receiver. The resulting reception signal ends the travel time measurement. One half of this travel time, multiplied by the constant speed of light, yields the distance of the target aimed at. The distance calculation is performed by a calculation program in the riflescope 80.

FIGS. 3 and 4 show a view of the visual beam path of the riflescope 80, and a view of the beam paths of the light emitter and the light receiver of the riflescope 80, respectively.

The erector lens 85, i.e., the erecting system of the riflescope 80, is adapted to turn the upside down and left-right reversed image to the right position. The erector lens 85 is also movable along the optical axis of the riflescope 80 to adjust the magnification of the riflescope 80. The first focal plane (objective plane) 88 and the second focal plane (eyepiece plane) 89 of the riflescope 80 are respectively located in front of and in rear of the erecting system along the viewing direction. FIG. 4 also shows the beam path of the LED panel 86. It can be seen that the image of data of the range of the LED panel 86 and the image of the reticle are projected on the same first focal plane 88. Accordingly, both the image of data of the range of the LED panel 86 and the reticle size will be affected by the erecting system 85. When observing the target from the eyepiece end for rangefinding, the shooter will find both the image of data of the range of the LED panel 86 and the reticle size grow or shrink along with the target image size when the power or magnification is changed. As shown in FIG. 5, when the magnification is increased, both the image of data of the range of the LED panel 86 and the reticle size are also increased along with the target image, whereby the target image is almost covered. In contrast, when the magnification is decreased, as shown in FIG. 6, both the image of data of the range of the LED panel 86 and the reticle size are also decreased along with the target image, whereby it may be difficult for the shooter to identify them. This sharp growing or shrinkage brings trouble to the shooter.

Therefore, an improved riflescope is desired to overcome the problem of sharp growing or shrinkage of the image of data of the range of the LED panel and the reticle size, whereby the shooter's vision feeling can be improved and higher magnification of the riflescope can be possibly achieved.

### SUMMARY OF THE INVENTION

Accordingly, the object of the present invention is to provide a riflescope having both the reticle and the image of data of the range of the target projected on the second focal plane (eyepiece plane) thereof, whereby the reticle size and the image of data of the range will not sharply grow or shrink, and the shooter's vision feeling thus can be improved.

To achieve the above object of the present invention, an optical system for a riflescope in accordance with the present invention includes the following optical elements: an objective element having the first focal plane, wherein the distance from the objective element to the first focal plane is defined as a first focal length; an eyepiece element aligning with the objective element to define an optical axis of the optical system and having a second focal plane, wherein the distance from the eyepiece element to the second focal plane is defined as a second focal length; an erector lens located between the first and second focal planes and transferring a target image from the first focal plane to the second focal plane; a light emitter for emitting a beam with a certain wavelength; a first guiding element for guiding the beam toward a target along the optical axis; a light receiver for receiving the beam reflected back by the target and then generating an electrical signal for measuring a range between the target and the riflescope; a second guiding element for guiding the beam reflected from the target to the light receiver; a reticle disposed at a distance of the second focal length so as to coincide with the second focal plane; a display panel for displaying the image of data of the range; and a third guiding element for projecting the image of data of the range to the second focal panel.

The light emitter and the first guiding element constitute the first optical sub-system for the riflescope of the present invention, the light receiver and the second guiding element constitute the second optical sub-system, and the display panel and the third guiding element constitute the third optical sub-system. The first, second and third guiding elements are polygonal prisms, which respectively include an LD prism, an APD prism and an LED prism.

The present invention is different from the prior art in that the reticle or aiming reference mark for the present riflescope is disposed at a distance of the second focal length so as to coincide with the second focal plane, and the image of data of the range displayed by the display panel is also projected on the second focal plane. This ensures that both the image of data of the range displayed by the display panel and the reticle size will not be affected by the erector lens, whereby sharp growing or shrinkage of the image of data of the range and the reticle size accompanying the magnification increase or decrease is prevented, and thus the shooter's vision feeling can be significantly improved. Additionally, as the APD prism and the LED prism of the present riflescope are separate from each other, rather than integrated as a unit by cementation, productivity is improved since only the beam splitter specification of a single prism, not a composite prism, is required to control.

### BRIEF DESCRIPTION OF THE DRAWINGS

The present invention may best be understood through the following description with reference to the accompanying drawings, in which:

FIG. 1 is an optical system for a conventional riflescope;

FIG. 2 is an optical system of another conventional riflescope;

FIG. 3 is a view of the visual beam path of the conventional riflescope shown in FIG. 2;

FIG. 4 is a view of the beam paths of a light emitter, a light receiver and an LED panel of the conventional riflescope shown in FIG. 2;

FIG. 5 is a view showing a high magnification image of the conventional riflescope shown in FIG. 2, wherein the reticle size and the image of data of the range displayed by the LED panel are extremely large;

FIG. 6 is a view showing a low magnification image of the conventional riflescope shown in FIG. 2, wherein the reticle size and the image of data of the range displayed by the LED panel are extremely small;

FIG. 7 is an optical system of a riflescope in accordance with the present invention;

FIG. 8 is a view of the visual beam path of the present riflescope;

FIG. 9 is a view of the beam paths of a light emitter, a light receiver and an LED panel of the present riflescope;

FIG. 10 is a view showing a high magnification image of the present riflescope; and

FIG. 11 is a view showing a low magnification image of the present riflescope, wherein the reticle size and the image of data of the range displayed by the LED panel remain the same as that of FIG. 10.

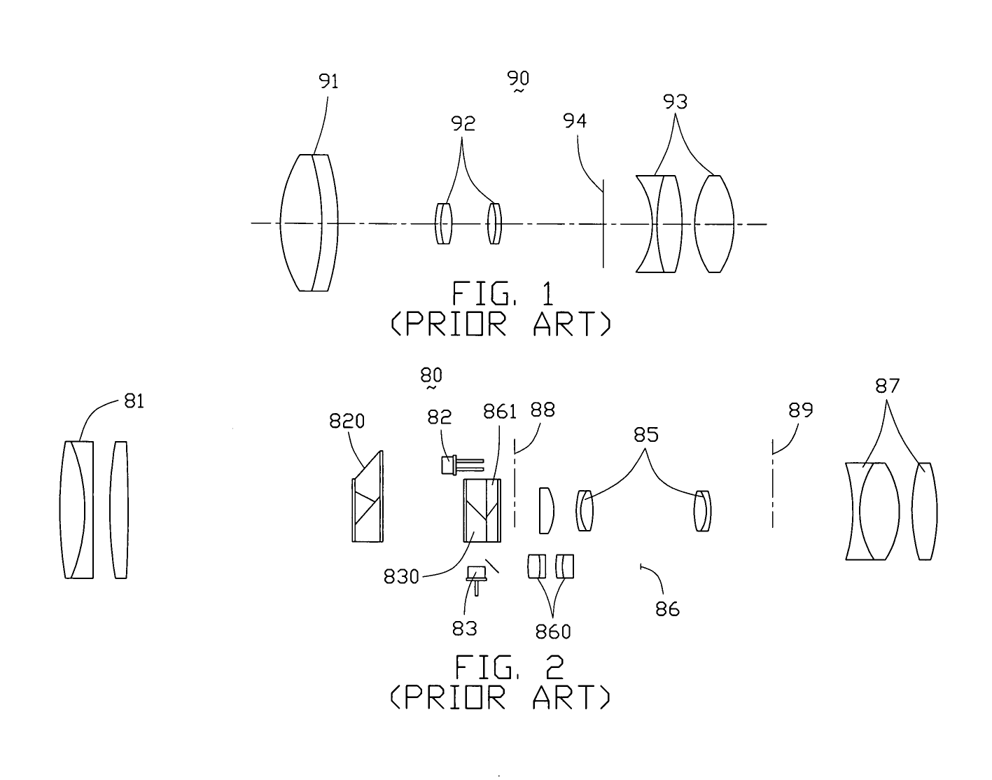

### DETAILED DESCRIPTION OF THE INVENTION

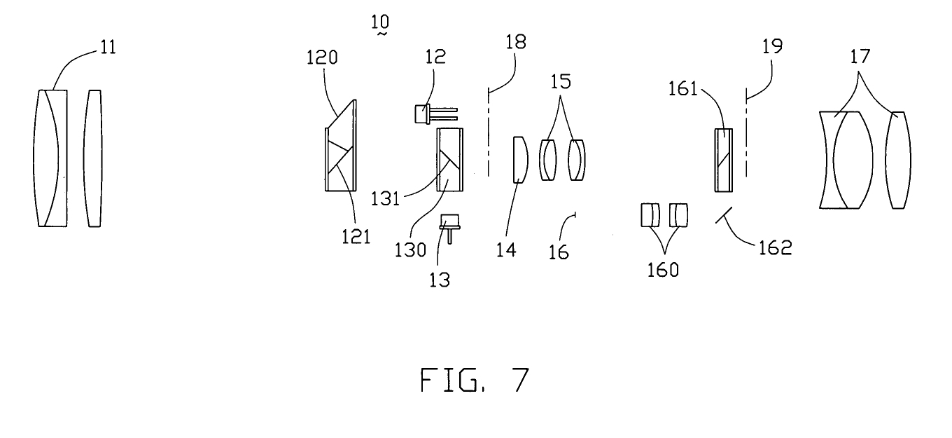

Referring to FIG. 7, a riflescope 10 in accordance with the present invention includes an objective element 11, a Laser Diode (LD) 12, an LD prism 120, an Avalanche Photoelectric Diode (APD) 13, an APD prism 130, a collector lens 14, an erector lens 15, a Light Emitting Diode (LED) panel 16, an LED lens element 160, an LED prism 161, a reticle and an eyepiece (ocular lens) element 17. The objective element 11, the eyepiece element 17, the erector lens 15 and the reticle together constitute a telescope system of the present riflescope 10. The objective element 11 has a first focal plane 18, wherein the distance from the objective element 11 to the first focal plane is defined as a first focal length. The eyepiece element 17 is aligned with the objective element 11 to define an optical axis of the optical system of the present riflescope 10. The eyepiece element 17 has a second focal plane 19, wherein the distance from the objective element 17 to the second focal plane is defined as a second focal length. The erector lens 15, also called an image magnification adjusting lens, is movable along the optical axis of the riflescope 10 to adjust the image magnification, and is adapted to turn the upside down and left-right reversed image to the right position. The erector lens 15 is also known as the erecting system of optical system of the present riflescope 10. The first and second focal planes 18, 19 are respectively positioned in front of and in rear of the erecting system along the viewing direction.

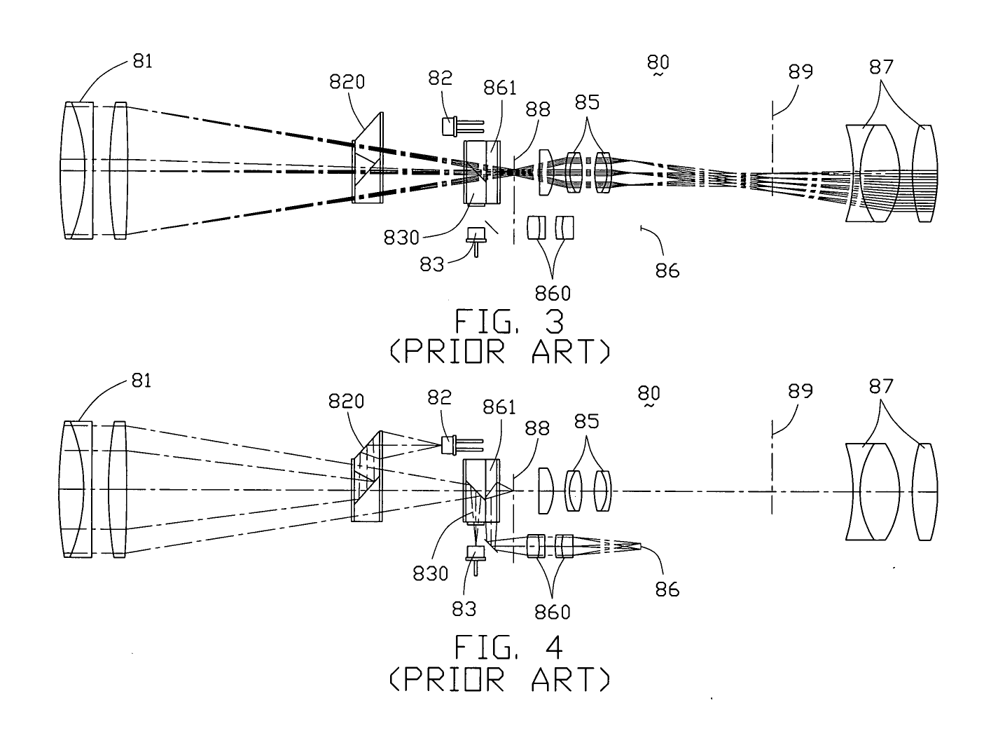

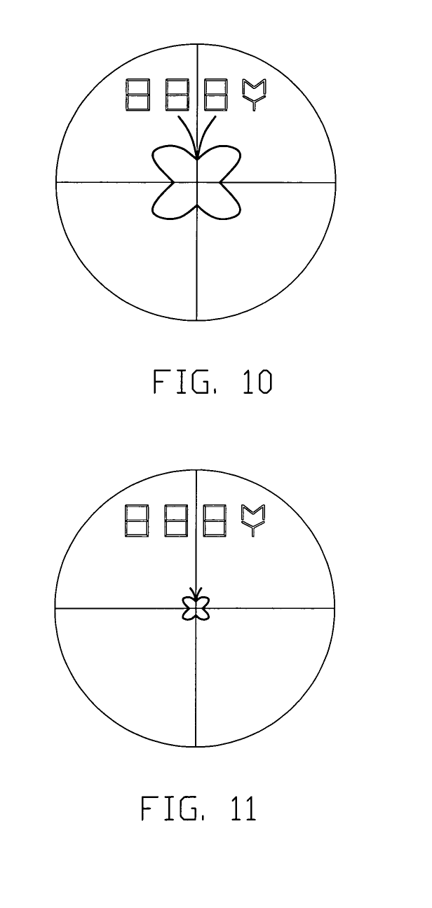

The main differences between the present riflescope 10 and the conventional riflescope 80 as shown in FIGS. 2-6 rely in that the reticle of the present riflescope 10 is disposed at a distance of the second focal length so as to coincide with the second focal plane 19, and the image of data of the range displayed by the LED panel 16 is also projected on the second focal plane 19. When observing the target from the eyepiece end for rangefinding, no matter for high magnification or low magnification, as shown in FIGS. 10 and 11, the shooter will find the image size and brightness of the image of data of the range and the reticle remain the same. In other words, the image of the reticle and the image of data of the range displayed by the LED panel 16 will not be affected by the erecting system, whereby sharp growing or shrinkage of the image of data of the range and the reticle size accompanying the magnification increase or decrease will not occur, and thus the shooter's vision feeling can be significantly improved. Furthermore, since the reticle of the present riflescope 10 is disposed at a distance of the second focal length coinciding with the second focal plane 19, when no power is available for precise rangefinding, the shooter may still use the reticle as an aiming reference mark to roughly estimate the target distance. This provides more flexibility to the present riflescope 10.

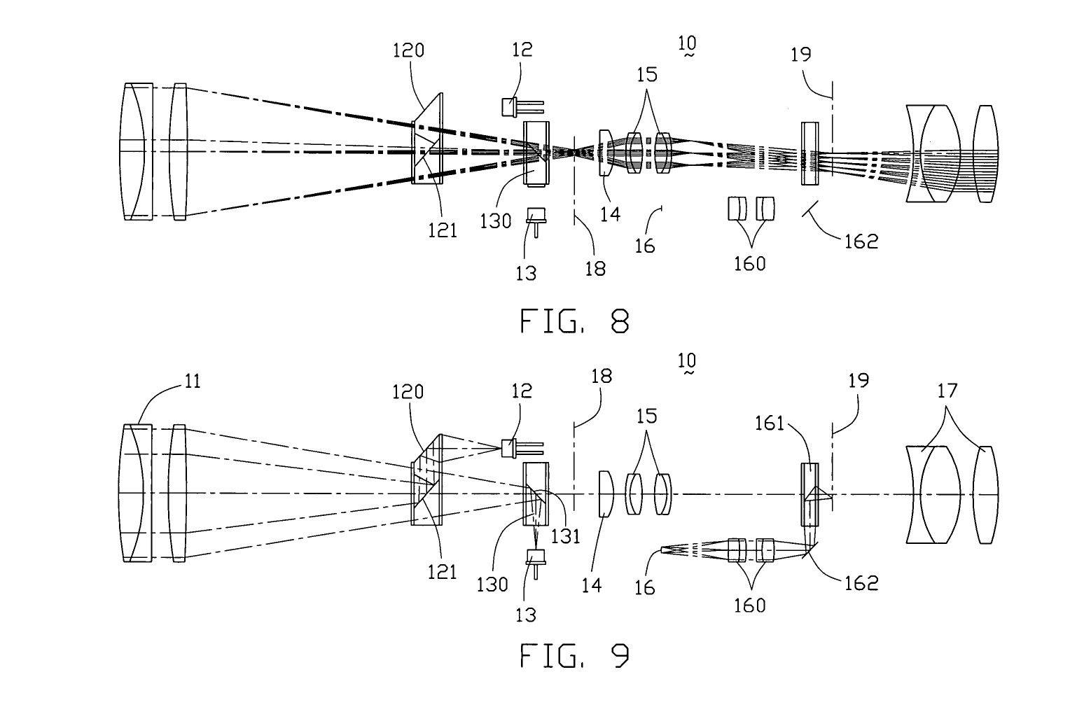

In the preferred embodiment of the present invention, the LD 12 is a light emitter for emitting a laser beam with a certain wavelength. The LD prism 120 is the first polygonal prism having a reflection surface disposed on the optical axis of the optical system of the riflescope 10. The LD prism 120 and a reflector 121 constitute the first guiding element, which is located between the objective element 11 and the first focal plane 18 for guiding the laser beam toward the target along the optical axis. The APD 13 acts as a light receiver or a receiving sensor for receiving the laser beam reflected back by the target and then generating an electrical signal for measuring a range between the target and the riflescope, which is then received and processed by a processing unit (not shown). The APD prism 130 is the second polygonal prism having a reflection surface disposed on the optical axis of the optical system of the riflescope 10. The APD prism 130 and a reflector 131 constitute the second guiding element, which is located between the objective element 11 and the first focal plane 18 for guiding the beam reflected from the target to the APD prism 13. The beam path of the optical system of the riflescope 10 is shown in FIG. 8, and the beam paths of the light emitter 12 and the light receiver 13 are shown in FIG. 9. It can be seen that the beam paths of the light emitter 12 and the light receiver 13 are both brought into the visual riflescope beam path coaxially. This ensures that the objective for the riflescope 10 is the same as that for the light emitter 12 and light receiver 13. Specifically, the beam path of the first optical sub-system, which is composed of the light emitter 12, the LD prism 120 and the reflector 121, is brought into the visual riflescope beam path. The beam path of the second optical sub-system, which is composed of the light receiver 13, the APD prism 130 and the reflector 131, is also brought into the visual riflescope beam path. It should be noted that the LD prism 120 and the APD prism 130 are provided with a dichroic coating which causes only the long-wave laser light to be reflected, while they are permeable for visible light. The above light emitter 12 and the light receiver 13 constitute a ranging system for the optical system of the present riflescope 10.

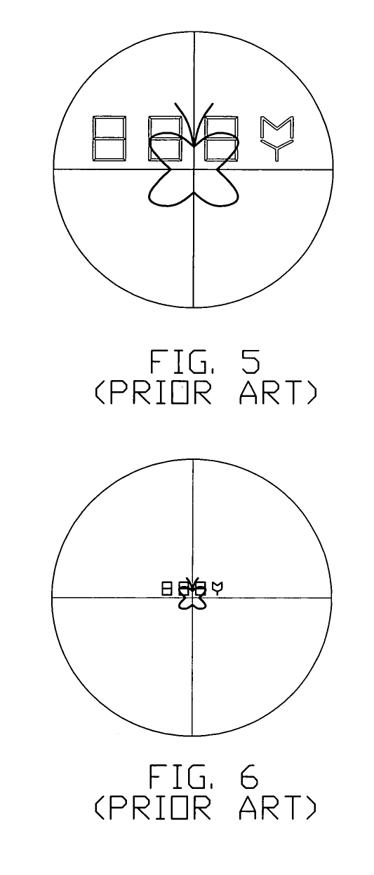

The LED panel 16, the LED lens element 160, the LED prism 161 and the reflector 162 constitute the third optical sub-system, which is a displaying system for the riflescope 10. The LED panel 16 is a display panel for displaying the image of data of the range from the processing unit. The LED prism 161 is the third polygonal prism, which is positioned between the second focal plane 19 and the erector lens 15 and having a reflection surface disposed on the optical axis. The LED prism 161 and the reflector 162 constitute the third guiding element. The LED lens element 160 and the third guiding element constitute an imaging system for projecting the image of data of the range displayed by the LED panel 16 to the second focal plane 19. Referring to FIG. 9 in conjunction with FIG. 4, it can be seen that the beam path of the third optical sub-system for the present riflescope 10 is set in a reversed manner to that of the prior art. That is, the image of data of the range displayed by the LED panel 16 is projected through the third optical sub-system on the second focal plane 19, whereby affection from the erector lens 15 can be prevented. Additionally, as shown in FIGS. 2-4, the conventional APD prism 830 and LED prism 861 are formed as an integral part. However, the requirements for the beam splitter specification of the single APD prism 830 and LED prism 861 are different from each other. When formed as an integral part such as by cementation, it cannot be ensured whether the composite prism still satisfies these requirements. To address this problem, the APD prism 130 and the LED prism 161 of the present riflescope 10 are separate from each other. Productivity thus can be improved since only the beam splitter specification of a single prism, not a composite prism, is required to control.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical system for a riflescope, comprising:
an objective element having a first focal plane, wherein the distance from the objective element to the first focal plane is defined as a first focal length;
an eyepiece element aligning with the objective element to define an optical axis of the optical system and having a second focal plane, wherein the distance from the eyepiece element to the second focal plane is defined as a second focal length;
an erector lens located between the first and second focal planes and transferring a target image from the first focal plane to the second focal plane;
a light emitter for emitting a beam with a certain wavelength;
a first guiding element for guiding the beam along the optical axis toward a target;
a light receiver for receiving the beam reflected from the target and generating an electrical signal for obtaining a range between the target and the riflescope;
a second guiding element for guiding the beam reflected from the target to the light receiver;
a reticle disposed at a distance of the second focal length so as to coincide with the second focal plane;
a display panel for displaying the image of data of the range; and
a third guiding element for projecting the image of data of the range to the second focal plane.

2. The optical system for a riflescope as claimed in claim 1, wherein the light emitter and the first guiding element constitute a first optical sub-system, the beam from the first optical sub-system being brought into the optical axis of the optical system.

3. The optical system for a riflescope as claimed in claim 2, wherein the light receiver and the second guiding element constitute a second optical sub-system, the beam reflected from the target enters the optical system and follows the optical axis to the light receiver via the second guiding element.

4. The optical system for a riflescope as claimed in claim 1, wherein the first guiding element has a reflector disposed on the optical axis, or a polygonal prism having a reflection surface on the optical axis.

5. The optical system for a riflescope as claimed in claim 1, wherein the second guiding element has a reflector disposed on the optical axis, or a polygonal prism having a reflection surface on the optical axis.

6. The optical system for a riflescope as claimed in claim 1, wherein the third guiding element has a reflector disposed on the optical axis, or a polygonal prism having a reflection surface on the optical axis.

7. An optical system for a riflescope with a rangefinder, comprising:
an objective element at a target end;
an eyepiece element at a shooter end, the eyepiece element aligning with the objective element to define an optical axis of the optical system;
a zoom lens located between the objective element and the eyepiece element, the zoom lens being movable along the optical axis of the optical system for zooming in and out;
a light emitter;
a light projecting system having a lens element for projecting a beam emitted by the light emitter to a target;
a light receiving system for receiving the beam reflected from the target and generating an electrical signal for obtaining a range between the target and the riflescope, the light receiving system including a receiving lens element and a receiver;
a reticle for facilitating aiming at a target by the shooter;
a processing unit for receiving and processing the electrical signal from the light receiving system;
a displaying device for displaying the image of data of the range from the processing unit on the optical axis of the riflescope, the image displaying position being between the eyepiece element and the image magnification adjusting lens.

8. The optical system for a riflescope with a rangefinder as claimed in claim 7, wherein the light emitter is an LD, the LD emitting the laser beam to the target through the light projecting system.

9. The optical system for a riflescope with a rangefinder as claimed in claim 8, wherein the light projecting system includes a reflector and an LD prism for bringing the beam emitted by the light emitter into coincidence with the optical axis of the optical system.

10. The optical system for a riflescope with a rangefinder as claimed in claim 8, wherein the receiving sensor of the light receiving system is in the form of an APD, and the receiving lens element of the light receiving system includes an APD prism, the APD prism having a light receiving optical axis coinciding with the optical axis of the optical system.

11. The optical system for a riflescope with a rangefinder as claimed in claim 7, wherein the displaying device includes a prism for projecting the image of data of the range on the optical axis of the optical system at a predetermined position, the size of the image of data of the range not changing with the operation of the zoom lens for facilitating reception by the shooter.

12. The optical system for a riflescope with a rangefinder as claimed in claim 11, wherein the displaying device includes an LED panel being disposed offset from the optical axis of the optical system and generating the image of data of the range, and a lens element with a reflector for projecting the image of data of the range of the LED panel on the prism.

13. An optical system of a riflescope, comprising:
a telescope system including an objective element forming a first focal plane with a first focal length from the objective element, an eyepiece element defining an optical axis of the telescope system together with the objective element and forming a second focal plane with a second focal length from the eyepiece element, an erector lens disposed between the first and the second focal planes, and an aiming reference mark coinciding with the second focal plane;
a ranging system including a laser emitter for emitting laser beam to a target and a laser receiver for receiving the laser beam reflected from the target so as to measure a range between the target and the riflescope; and
a displaying system including a display element for displaying an image of data of the range and a guiding group for projecting the image on the second focal panel.

14. The optical system of a riflescope as claimed in claim 13, wherein the guiding group comprises a third guiding element including a reflector or a third polygonal prism for guiding the image to the second focal plane, and a first lens positioned between the third guiding element and the display element.

15. The optical system of a riflescope as claimed in claim 14, wherein the optical axis of the telescope system coincides with that of the ranging system.

16. The optical system of a riflescope as claimed in claim 15, wherein the ranging system further comprises a first guiding element for guiding the laser beam of the laser emitter along the optical axis of the telescope system.

17. The optical system of a riflescope as claimed in claim 16, wherein the first guiding element includes a reflector or a first polygonal prism having a reflection surface on the optical axis of the telescope system.

18. The optical system of a riflescope as claimed in claim 16, further comprising a second guiding element for guiding the laser beam from the telescope system to the light receiver.

19. The optical system of a riflescope as claimed in claim 18, wherein the second guiding element includes a reflector, or a second polygonal prism having a reflection surface on the optical axis of the telescope system.

20. The optical system of a riflescope as claimed in claim 13, wherein the aiming reference mark is a reticle.
